(19) United States
(12) Patent Application Publication
(10) Pub. No.: US 2011/0113970 A1
(43) Pub. Date: May 19, 2011

(54) Volume Measuring Water Supply Device of Beverage Brewing Machine

(76) Inventor: TSUNG-HSI LIU, Taipei (TW)

(21) Appl. No.: 12/618,709

(22) Filed: Nov. 14, 2009

(51) Int. Cl. A47J 31/44

(52) U.S. Cl. 99/300

(57) ABSTRACT

A volume measuring water supply device of a beverage brewing machine includes a cold water manifold coupled to the cold water supply pipe of the beverage brewing machine for flowing cold water out from the beverage brewing machine, a cold water solenoid valve provided for a control of opening or shutting the cold water, a hot water manifold coupled to the hot water supply pipe of the beverage brewing machine for flowing hot water out from the beverage brewing machine, a hot water solenoid valve provided for a control of opening or shutting the hot water manifold, and a water supply pipe, coupled to the cold water manifold and the hot water manifold for filling the cold water and the hot water respectively into a brewed beverage.

### BACKGROUND OF THE INVENTION

1. Field of the Invention

The present invention relates to a volume measuring water supply device of a beverage brewing machine that can fill a measured volume of cold and/or hot water into a beverage to adjust the concentration, temperature and volume of the beverage.

2. Description of the Related Art

In general, a beverage brewing machine is provided for brewing Italian coffee, tea or other beverages. With reference to FIG. 6 for a conventional beverage brewing machine, the machine comprises a water supply pump 80, a main boiler 81, a heat exchanger 82 and a brewing unit 83. The water supply pump 80 is provided for supplying external water into the main boiler 81, and a water level detector 84 is provided for a control of opening or shutting a solenoid valve 95 in order to selectively enter water into the water supply pump 80 and the boiler 81, and maintain a water level in the main boiler 81 within a set range, and a steam pressure detector 85 is provided for a control of turning on or off a heater 86 to heat the water stored in the main boiler 81 and maintain the steam within a predetermined vapor pressure range (as well as a predetermined temperature range).

During a beverage brewing procedure, the water supply pump 80 and a brewing solenoid valve 87 are turned on to pass external water sequentially through a cold water supply pipe 88, a one-way pressure release valve 89 and a flow meter 90 into the heat exchanger 82 penetrated through the main boiler 81, and hot water and steam in the main boiler 81 are used for heating up the external water contained in the heat exchanger 82 into hot water, and the hot water is passed through a hot water supply pipe 91 into the brewing unit 83, and further passed through the opened brewing solenoid valve 87 to flow down into a pre-installed filter cup 92 for brewing a beverage brewing material, and finally the brewed beverage flows into a beverage containing cup 94. If the flow meter 90 measures the flow of water up to a set flow, the flow meter 90 will shut the brewing solenoid valve 87 to complete the beverage brewing procedure according to the set flow.

If the beverage brewing machine is in a standby mode which does not carry out the beverage brewing procedure, the hot water contained in the heat exchanger 82 will be vaporized into steam due to the thermal evaporation, and the steam will pass through the hot water supply pipe 91 into the brewing unit 83. Since the brewing solenoid valve 87 is shut at the standby mode, the steam flow and the brewing unit 83 perform a thermal exchange to preheat the brewing unit 83 to a working temperature, and the steam is condensed into water after the thermal exchange takes place with the brewing unit 83, and then the condensed water returns from a return pipe 93 into the heat exchanger 82 to constitute a preheat circulation.

If the aforementioned conventional beverage brewing machine is used for brewing a large-volume beverage (such as a beverage of 360 cc or 500 cc), the following two methods are generally used:

1. The large-volume beverage is brewed directly by the brewing unit 83; and

2. Only a small quantity of concentrated liquid is brewed from the brewing unit 83, and then additional hot water is added into the concentrated liquid to adjust the volume of the beverage to a desired volume.

Since present existing brewing machines can use the aforementioned two brewing methods to make a beverage of a desired volume or adjust the beverage to a desired volume, therefore these conventional brewing machines still have the following drawbacks:

1. The large-volume beverage brewed directly from the brewing unit 83 has a high temperature, and a consumer's direct drinking of such a hot beverage should be taken into consideration for a commercial application to prevent the consumer from getting burned, or the consumer is requested to wait till the beverage cools down before drinking it, and obviously this conventional method causes inconvenience to consumers.

2. The method of brewing a smaller quantity of concentrated liquid from the brewing unit 83 and manually adding additional hot water not only causes inconvenience to the consumers, but also incurs a low efficiency of producing the beverage.

3. Different beverages require different specific brewing time to achieve the best taste, and present existing brewing machines generally come with a single flow function only, and thus it usually extends the brewing time of brewing a large-volume beverage directly from the brewing unit 83, and the large-volume brewed beverage usually loses its best taste.

To overcome the aforementioned drawbacks of the prior art, the inventor of the present invention has filed U.S. patent application Ser. No. 12/220,649 (hereinafter referred to as a “cited reference”) and provided a concentration and temperature controlled brewing machine, comprising: a pump; a heating device, connected to the pump; a heat exchanger, installed in the heating device and connected to the pump; a brewing unit, connected to the heat exchanger; and a makeup unit, for guiding water before entering into the heat exchanger and after flowing out from the heat exchanger to adjust the final volume and temperature of the beverage brewed by the brewing unit. The brewing machine of the cited reference brews a beverage directly from the brewing unit, or adjusts the volume and temperature of the brewed beverage by the makeup unit. In summation, the brewing machine of the cited reference has the effects of controlling both temperature and concentration of the brewed beverage.

The makeup unit is connected to a cold water pipe module and includes a makeup pipe, a cold water throttle valve and a solenoid valve, wherein the makeup pipe is extended from the cold water pipe module and has a makeup opening formed at a position away from the cold water pipe module, and the cold water throttle valve is installed on the makeup pipe, and the solenoid valve is installed on the makeup pipe; and a manifold, having an end connected to a hot water supply pipe, and another end connected to the makeup pipe between the cold water throttle valve and the solenoid valve, and the manifold includes a hot water throttle valve.

The brewing machine in accordance with the cited reference is provided for brewing a regular-volume concentrated beverage or a large-volume diluted beverage, and efficiently providing the effect of brewing a large-volume diluted beverage with a desired temperature. However, the brewing machine of the cited reference still has the following technical issues:

1. When the brewing unit is used for carrying out the beverage brewing procedure, the solenoid valve installed on the makeup pipe is shut, and the hot water heated by the heat exchanger flows through the hot water supply pipe into the brewing unit for brewing a beverage, but a portion of cold water also flows through the makeup pipe and the manifold into the hot water supply pipe and mixes with the original hot water in the hot water supply pipe, such that the water finally entering into the brewing unit for brewing the beverage is not a mixed cold and hot water that reaches the best brewing temperature, and the brewed beverage loses its best taste.

2. Although the brewing machine of the cited reference includes a cold water throttle valve and a hot water throttle valve installed on a makeup pipe and a manifold of the brewing machine for adjusting the flow, the mixed cold and hot water flows through the makeup opening into the beverage containing cup to adjust the concentration and temperature of the beverage. However, the cold water throttle valve and the hot water throttle valve adjust the flow according to factory default settings. In other words, cold and hot water are mixed according to a specific ratio. Since the most appropriate drinking temperature and concentration for different types of beverages (such as coffee and tea) vary, therefore a fixed mixing ratio of the cold and hot water for producing a makeup water flow mixed by the brewing machine of the cited reference at a fixed temperature cannot meet the requirement of adjusting two or more different types of beverage to their most appropriate drinking temperature and concentration.

### SUMMARY OF THE INVENTION

Therefore, it is a primary objective of the present invention to provide a volume measuring water supply device of a beverage brewing machine, capable of automatically filling water of a measured volume and a set temperature into a brewed beverage to increase the volume of the beverage, and adjust the beverage to the best drinking temperature and concentration.

Another objective of the present invention is to provide a volume measuring water supply device of a beverage brewing machine, such that when a beverage brewing procedure is carried out, water supply is prevented from flowing into a hot water supply pipe to avoid cooling down the hot water in the hot water supply pipe for brewing the beverage, and maintain the best brewing temperature.

A further objective of the present invention is to provide a volume measuring water supply device of a beverage brewing machine capable of changing the flow and temperature of supplied water according to the type of a beverage, so that different types of beverages (such as coffee and tea) can be adjusted to the best drinking temperature and concentration by the supplied water of appropriate quantity and temperature.

Another objective of the present invention is to provide a volume measuring water supply device of a beverage brewing machine, wherein the brewing machine can mix cold water and hot water into makeup water at an appropriate temperature in advance, and fills the makeup water into the brewed beverage automatically, or control the cold and hot water to be filled into the brewed beverage at a different time.

To achieve the foregoing objectives, the present invention provides a volume measuring water supply device of a beverage brewing machine, wherein the beverage brewing machine comprises a cold water supply pipe, a heat exchanger for heating up the cold water to a set temperature, a brewing unit for carrying out a beverage brewing procedure, and a hot water supply pipe for transmitting the hot water heated by the heat exchanger to the brewing unit; and the volume measuring water supply device comprises: a cold water manifold coupled to the cold water supply pipe of the beverage brewing machine for flowing cold water out from the beverage brewing machine, a cold water solenoid valve provided for a control of opening or shutting the cold water manifold, a hot water manifold coupled to the hot water supply pipe of the beverage brewing machine for flowing hot water out from the beverage brewing machine, a hot water solenoid valve provided for a control of opening or shutting the hot water manifold, and a water supply pipe, coupled to the cold water manifold and the hot water manifold for filling the cold water and the hot water respectively into a brewed beverage.

The cold water manifold further includes a cold water throttle valve for adjusting the flow of the supply of cold water.

The hot water manifold further includes a hot water throttle valve for adjusting the flow of the supply of hot water.

The water supply pipe further includes a water supply throttle valve for adjusting the flow of the makeup water.

### BRIEF DESCRIPTION OF THE DRAWINGS

The technical characteristics and objectives of the present invention can be further understood by the following detailed description of preferred embodiments and related drawings in which:

FIG. 1 is a perspective view of a volume measuring water supply device of a beverage brewing machine in accordance with a first preferred embodiment of the present invention;

FIG. 2 is a perspective view of a volume measuring water supply device in accordance with a second preferred embodiment of the present invention;

FIG. 3 is a perspective view of a volume measuring water supply device in accordance with a third preferred embodiment of the present invention;

FIG. 4 is a perspective view of a volume measuring water supply device in accordance with a fourth preferred embodiment of the present invention;

FIG. 5 is a perspective view of a volume measuring water supply device in accordance with a fifth preferred embodiment of the present invention; and

FIG. 6 is a perspective view of a conventional beverage brewing machine.

### DETAILED DESCRIPTION OF THE INVENTION

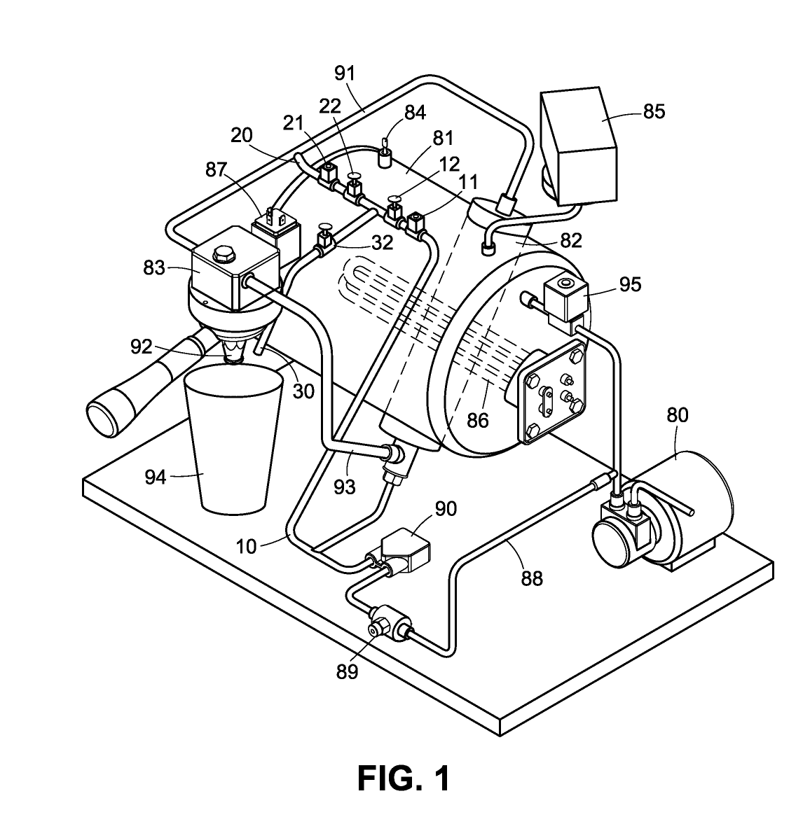

With reference to FIG. 1, a volume measuring water supply device of a beverage brewing machine in accordance with the present invention automatically fills makeup water with a measured volume and a set temperature into a brewed beverage to increase the volume of the beverage and adjust the beverage to its most appropriate drinking temperature and concentration.

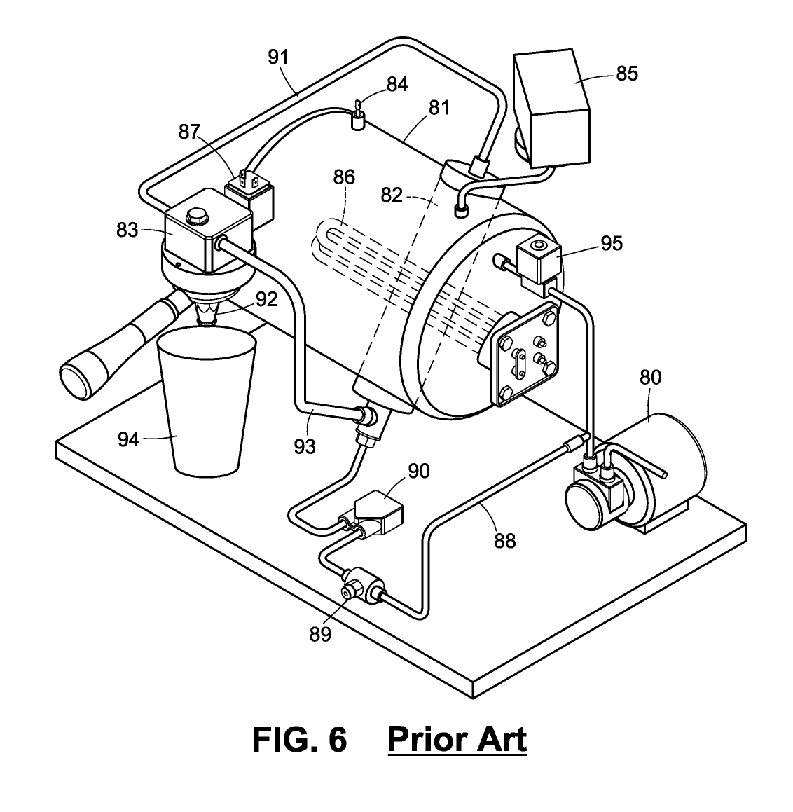

The beverage brewing machine comprises a cold water supply pipe 88, a heat exchanger 82 for heating up the cold water to a set temperature, a brewing unit 83 for carrying out a beverage brewing procedure, and a hot water supply pipe 91 for transmitting the hot water heated by the heat exchanger 82 to the brewing unit 83. The beverage brewing machine further comprises: a water supply pump 80, a boiler water supply solenoid valve 95, a main boiler 81, a water level detector 84, a steam pressure detector 85, a heater 86, a brewing solenoid valve 87, a one-way pressure release valve 89, a flow meter 90, a filter cup 92, and a return pipe 93, and its structural characteristics and operation method are substantially the same as the conventional beverage brewing machine as shown in FIG. 6, and thus will not be described here again. The beverage brewed by the beverage brewing machine flows into a beverage containing cup 94 for its storage.

The present invention is characterized in that the beverage brewing machine further comprises a volume measuring water supply device capable of automatically filling makeup water with a measured volume and a set temperature into a brewed beverage. The volume measuring water supply device comprises: a cold water manifold 10 connected to the cold water supply pipe 88 for guiding cold water to flow out; a cold water solenoid valve 11 provided for a control of opening or shutting the cold water manifold 10; a hot water manifold 20 connected to the hot water supply pipe 91 for guiding hot water to flow out; a hot water solenoid valve 21 provided for a control of opening or shutting the hot water manifold 20; and a water supply pipe 30 connected to the cold water manifold 10 and the hot water manifold 20 for filling the cold water and the hot water into the brewed beverage respectively.

During a beverage brewing procedure, the cold water solenoid valve 11 and the hot water solenoid valve 21 are shut, such that the cold water in the cold water supply pipe 88 can only flow into the heat exchanger 82 for heating, and the heated hot water flows through the hot water supply pipe 91 into the brewing unit 83 for carrying out the beverage brewing procedure.

If a user sets a water supply procedure from a control panel (not shown in the figure) in advance, then the cold water solenoid valve 11 and/or the hot water solenoid valve 21 can be set to be opened simultaneously or separately by a program after the brewing unit 83 has finished the beverage brewing procedure, such that the makeup cold water in the cold water manifold 10 and/or the makeup hot water in the hot water manifold 20 are filled automatically into the brewed beverage through the water supply pipe 30 at the same time to increase the volume of the beverage and adjust the beverage to its most appropriate drinking temperature and concentration

In the aforementioned water supply procedure, the supply of water will stop as long as the flow meter 90 has calculated a water flow equal to a predetermined flow.

A user can preset the following different water supply procedures according to the types of beverages and the customer requirements:

1. Supplying Hot Water: Only the hot water solenoid valve 21 is opened for carrying out a water supply procedure, such that the makeup hot water in the hot water manifold 20 can be passed through the water supply pipe 30 and filled into a brewed beverage automatically to increase the volume of the beverage and reduce the concentration of the beverage without changing the temperature of the beverage.

2. Supplying Cold Water: Only the cold water solenoid valve 21 is opened for carrying out a water supply procedure, such that the makeup cold water in the cold water manifold 20 can be passed through the water supply pipe 30 and filled into a brewed beverage automatically to increase the volume of the beverage and reduce both concentration and temperature of the beverage at the same time.

3. Supplying Warm Water: Both cold water solenoid valve 11 and hot water solenoid valve 21 are opened for carrying a water supply procedure, such that the makeup cold water in the cold water manifold 10 and the makeup hot water in the hot water manifold 20 are mixed in the water supply pipe 30 to produce warm water of an appropriate temperature, and then the warm water is filled into a brewed beverage automatically to increase the volume of the beverage and reduce both concentration and temperature of the beverage at the same time.

The time duration and the timing for opening the cold water solenoid valve 11 and the hot water solenoid valve 21 can be controlled by a program, such that a beverage can be adjusted to the most appropriate drinking concentration and temperature according to the type of the beverage.

In a preferred embodiment of the present invention, the cold water manifold 10 further includes a cold water throttle valve 12 installed thereon for adjusting the flow of the makeup cold water. The hot water manifold 20 further includes a hot water throttle valve 22 installed thereon for adjusting the flow of the makeup hot water. The water supply pipe 30 further includes a water supply throttle valve 32 for adjusting the flow of the makeup water. Each throttle valve 12, 22, 32 can be used for controlling the flow of the makeup water precisely and preventing the beverage contained in beverage containing cup 94 from being spilling out due to a too-large flow of the makeup water.

Each throttle valve 12, 22, 32 can be a fixed throttle valve having a fixed openness, or a variable throttle valve having an adjustable openness for adjusting the supply of cold water and/or hot water into the most appropriate flow to be filled into the beverage.

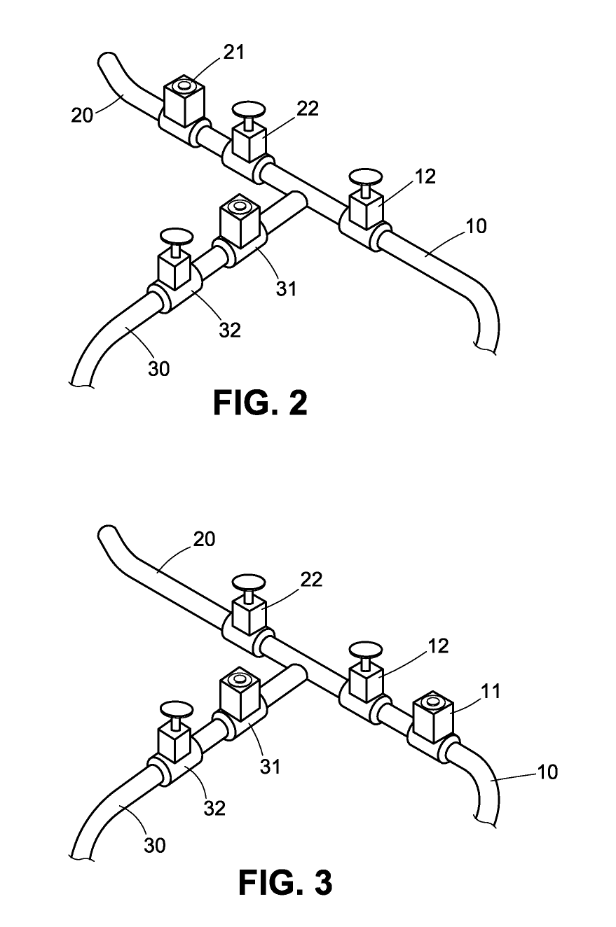

With reference to FIG. 2 for another preferred embodiment of the present invention, the water supply pipe 30 can selectively include a water supply solenoid valve 31 to serve as a master switch for the makeup water. If the water supply solenoid valve 31 is installed, then the cold water solenoid valve 11 on the cold water manifold 10 can be omitted selectively.

With reference to FIG. 3 for another preferred embodiment of the present invention, the water supply pipe 30 can selectively include a water supply solenoid valve 31 to serve as a master switch for the makeup water. If the water supply solenoid valve 31 is installed, then the hot water solenoid valve 21 on the hot water manifold 20 can be omitted selectively.

With reference to FIGS. 2 and 3, even if the water supply pipe 30 includes a water supply solenoid valve 31 that serves as a master switch for the makeup water, the interconnected cold water manifold 10 and hot water manifold 20 still requires at least one cold water solenoid valve 11 or hot water solenoid valve 21, such that when the beverage brewing procedure is carried out, the cold water solenoid valve 11 or hot water solenoid valve 21 is controlled and maintained shut, so that the cold water in the cold water manifold 10 will not flows through the hot water manifold 20 into the hot water supply pipe 91, so as to avoid the hot water stored in the hot water supply pipe 91 and used for brewing will not be cooled, and to maintain the best brewing temperature of the beverage.

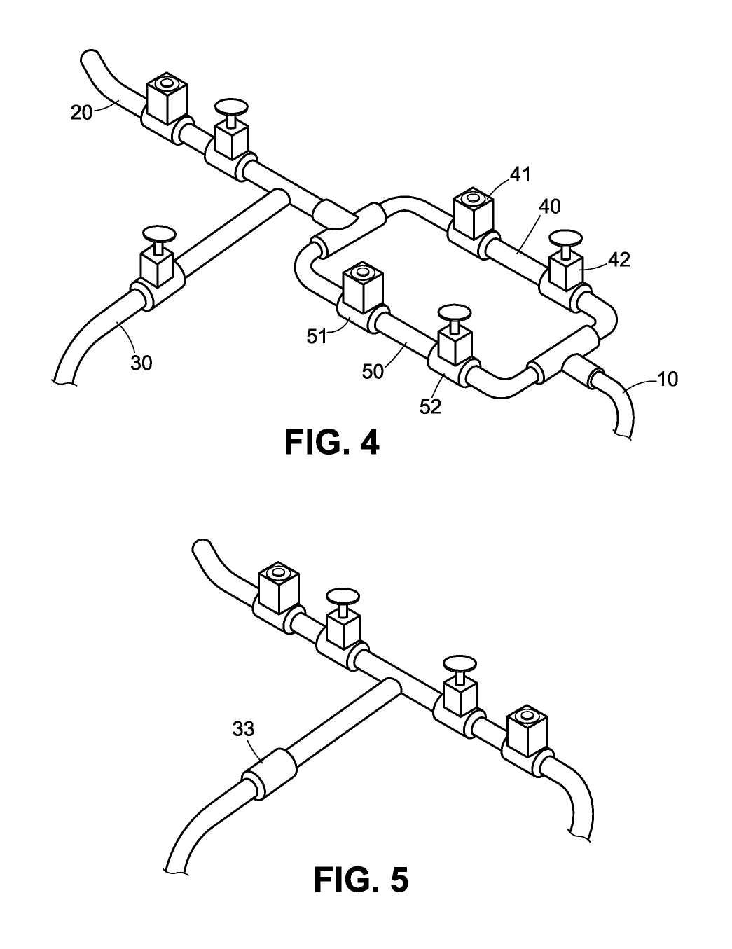

With reference to FIG. 4 for another preferred embodiment of the present invention, the cold water manifold 10 further includes at least two set of parallel cold water split pipes 40, 50, each having a cold water split pipe solenoid valve 41, 51 provided for a control of opening or shutting the cold water split pipe 40, 50 and a cold water split pipe throttle valve 42, 52 having a different default openness. During a water supply procedure for a different type of beverage, a cold water split pipe can be selected by a program control to open the cold water split pipe solenoid valve, and shut the remaining sets of the cold water split pipe solenoid valves; such that the makeup cold water in the cold water manifold 10 can flow into the cold water split pipe selectively, and then its flow can be adjusted by the cold water split pipe throttle valve having the most appropriate openness, and the makeup cold water flows from the opened cold water split pipe solenoid valve into the water supply pipe 30, such that the makeup cold water is mixed with the makeup hot water flowing out from the hot water manifold 20 to produce warm water at the most appropriate temperature for drinking the beverage.

With reference to FIG. 5 for another preferred embodiment of the present invention, the water supply throttle valve installed on the water supply pipe 30 can be replaced by a water supply throttle joint 33 having a fixed openness.

The throttle valve used in the present invention can be a fixed throttle valve, a variable throttle valve or a throttle joint.

Compared with the cited reference and other prior arts, the volume measuring water supply device of a beverage brewing machine in accordance with the present invention has the following advantages:

1. The invention can automatically fill makeup water with a measured volume and a set temperature into a brewed beverage to increase the volume of the beverage and adjust the beverage to its most appropriate drinking temperature and concentration.

2. The invention can prevent the makeup water from flowing into the hot water supply pipe in a beverage brewing procedure to avoid the hot water stored in the hot water supply and used for brewing is cooled down by the makeup water, so as to maintain the best brewing temperature.

3. The invention can change the flow and temperature of the makeup water according to the types of beverages, such that different types of beverages (such as coffee and tea) can be adjusted to the most appropriate drinking temperature and concentration by the makeup water at an appropriate temperature and with an appropriate quantity.

4. The invention can selectively mix the cold water and the hot water into makeup water with an appropriate temperature in advance, wherein the mixed water is filled into the brewed beverage automatically, or control the cold water and hot water to be filled into the brewed beverage at a different time.

In summation of the description above, the present invention improves over the prior art and complies with the patent application requirements, and thus is duly filed for patent application.

What is claimed is:

1. A volume measuring water supply device of a beverage brewing machine, and the beverage brewing machine comprising a cold water supply pipe, a hot water supply pipe and a brewing unit for receiving hot water supplied through the hot water supply pipe and carrying out a beverage brewing procedure, and the volume measuring water supply device comprising:
a cold water manifold, coupled to the cold water supply pipe, for flowing cold water out from the cold water manifold;
a cold water solenoid valve, provided for a control of opening or shutting the cold water manifold;
a hot water manifold, coupled to the hot water supply pipe, for flowing hot water out from the hot water manifold;
a hot water solenoid valve, provided for a control of opening or shutting the hot water manifold; and
a water supply pipe, coupled to the cold water manifold and the hot water manifold, for filling the cold water and the hot water respectively into a brewed beverage.

2. The volume measuring water supply device of a beverage brewing machine as recited in claim 1, wherein the cold water manifold further includes a cold water throttle valve installed thereon for adjusting a flow of the supplied cold water.

3. The volume measuring water supply device of a beverage brewing machine as recited in claim 1, wherein the hot water manifold further includes a hot water throttle valve installed thereon for adjusting a flow of the supplied hot water.

4. The volume measuring water supply device of a beverage brewing machine as recited in claim 1, wherein the water supply pipe further includes a throttle valve installed thereon for adjusting a flow of the supplied water.

5. The volume measuring water supply device of a beverage brewing machine as recited in claim 1, wherein the water supply pipe further includes a water supply throttle joint for adjusting a flow of the supplied water.

6. The volume measuring water supply device of a beverage brewing machine as recited in claim 1, further comprising a water supply solenoid valve provided for a control of opening or shutting the water supply pipe.

7. The volume measuring water supply device of a beverage brewing machine as recited in claim 1, wherein the cold water manifold further includes at least two sets of parallel cold water split pipes, and each set of cold water split pipe includes a cold water split pipe solenoid valve provided for a control of opening or shutting the cold water split pipe and a cold water split pipe throttle valve having a variable predetermined openness.
